(19) United States
(12) Patent Application Publication
(10) Pub. No.: US 2014/0076728 A1
(43) Pub. Date: Mar. 20, 2014

(54) CONCENTRATION POLARIZATION IDENTIFICATION AND MITIGATION FOR MEMBRANE TRANSPORT

(71) Applicant: Ohio State Innovation Foundation, Columbus, OH (US)

(72) Inventors: Shaurya Prakash, Columbus, OH (US); Karen Bellman, Columbus, OH (US)

(73) Assignee: Ohio State Innovation Foundation, Columbus, OH (US)

(21) Appl. No.: 14/032,164

(22) Filed: Sep. 19, 2013

Related U.S. Application Data
(60) Provisional application No. 61/702,929, filed on Sep. 19, 2012.

(51) Int. Cl. C02F 1/469; B01D 61/42

(52) U.S. Cl. CPC C02F 1/4693; B01D 61/422
USPC 204/518; 204/627; 96/4

(57) ABSTRACT

Disclosed herein is a membrane separation apparatus with reduced concentration polarization and enhanced permeate flux. Also disclosed is a method for separating permeate from retentate in a fluid using the disclosed membrane separation apparatus. Also disclosed is a method for inhibiting or preventing concentration polarization of a permeable membrane used in membrane separation.

### CROSS-REFERENCE TO RELATED APPLICATIONS

This application claims benefit of U.S. Provisional Application No. 61/702,929, filed Sep. 19, 2012, which is hereby incorporated herein by reference in its entirety.

### STATEMENT REGARDING FEDERALLY SPONSORED RESEARCH OR DEVELOPMENT

This invention was made with Government Support under Grant No. 60024176 awarded by the Defense Advanced Research Projects Agency. The Government has certain rights in the invention.

### TECHNICAL FIELD

This invention relates to methods and devices for membrane separation, in particular for identifying and mitigating concentration polarization during membrane separation.

### BACKGROUND

Membrane separation techniques involve the separation, concentration, and/or purification of a raw material using a selective permeation membrane where components of the raw material selectively permeate the membrane when there is a driving force (e.g., pressure difference, concentration difference, potential difference, or temperature difference). Different membranes and driving forces are employed in different membrane separation processes. Examples of membrane separation processes that have been industrially used include microfiltration, ultrafiltration, reverse osmosis, dialysis, electrodialysis, gas separation, pervaporation, and emulsion liquid membrane. In addition, there are many membrane separation processes under development, such as membrane extraction, membrane distillation, bipolar membrane electrodialysis, membrane split phase, membrane absorption, membrane reaction, membrane control release, and membrane biosensor. Membrane separation techniques are widely applied in petrochemical industry, biological pharmaceutical industry, medical and sanitation fields, metallurgy industry, electronics, energy field, light industry, textile industry, food industry, environmental protection industry, aerospace industry, maritime transport industry, and daily life field.

However, concentration polarization during membrane separation processes affects membrane flux and causes membrane fouling. Concentration polarization arises in membranes when rejected solutes accumulate at the membrane surface. The rejected solutes can cause apparent fouling and significantly impede solvent flux through the membrane. The impediment to flux is due to the rise in local osmotic pressure at the membrane surface, which causes a decrease in the effective driving pressure.

In membranes and micro/nanoscale fluidic devices, concentration polarization can obstruct the flow, causing a shift from a linear relationship between applied voltage and current density (ohmic region) to an voltage independent current flow region (limiting region), where current density is used to monitor the amount of flow through the membrane. Eventually the relationship between applied voltage and current density returns to a linear relationship with a smaller slope than seen in the ohmic region (overlimiting region). This trend arises in electrokinetic flows. Furthermore, many systems work with pressure-driven flows and also exhibit a reduction in measurable flux due to concentration polarization. This voltage current behavior can be seen for any charge selective membrane or non-porous membrane that is being used to separate a purely electrolyte solution. For membranes separating particles and molecules larger than ions, a ‘cake layer’ can be formed, thus preventing the overlimiting region from forming and potentially causing an overall decline in flux as the cake formation progresses.

Current methods of polarization reduction can be classified into three broad categories, (i) mechanical, (ii) chemical, and (iii) electrical. Mechanical methods of polarization reduction include any method that can be achieved with mechanical agitation to the fluid surrounding the membrane, including but not limited to mixing, module vibration, and flow pulsing. Chemical methods include chemical surface modification of the membrane or solution to be separated. Electrical methods include applying an electrical, magnetic or a combination field on or near the membrane in order increase flux by mitigating concentration polarization. However, current methods of polarization reduction are not able to achieve flux enhancement with low energy costs.

### SUMMARY

Disclosed herein is a membrane separation apparatus with reduced concentration polarization and enhanced permeate flux. The apparatus comprises a feed chamber and a permeation chamber separated by a fluid permeable membrane. The permeable membrane comprises a separation side in contact with the feed chamber and a permeation side in contact with the permeation chamber. The apparatus also comprises a primary electrode positioned at the fluid boundary layer of the permeable membrane. The apparatus can also comprise an AC voltage source configured to supply a voltage less than 25 V, including between 0.5 and 10 V, to the primary electrode.

The fluid boundary layer can be determined by one of ordinary skill in the art. However, in some embodiments, the primary electrode is positioned at a location within 10, 20, 30, 40, 50, 60, 70, 80, 90, or 100 μm from the permeable membrane. In some embodiments, the electrode is positioned on the separation side of the permeable membrane; however a reverse orientation is also contemplated.

In some embodiments, the primary electrode comprises a conductive mesh positioned adjacent to the membrane. In other embodiments, the permeable membrane is plated with a conductive material on the separation side that acts as the primary electrode.

The apparatus also comprises a counter electrode, e.g., positioned on the permeation side of the permeable membrane. For example, the counter electrode can be positioned within the permeation chamber or at a location within 10, 20, 30, 40, 50, 60, 70, 80, 90, or 100 μm from the permeation side of the permeable membrane. As with the primary electrode, the counter electrode can comprise a conductive mesh, or the permeable membrane can be plated with a conductive material on the permeation side that acts as the counter electrode. Other configurations are contemplated so long as at least one electrode is positioned at the fluid boundary layer of the permeable membrane.

The AC voltage source can be configured to apply the voltage at an oscillation frequency between 1 kHz and 10 MHz. For example, the AC voltage source can be a wave form generator.

The apparatus can further comprise a fluid having retention components and permeation components in the feed channel. In particular, the fluid can have one or more charged species that can otherwise cause concentration polarization at the membrane surface. For example, the fluid can be selected from the group consisting of a solution, a liquid-solid suspensoid, a liquid-liquid suspensoid, a sol, a gas mixture, a gas-solid suspensoid, a gas-liquid suspensoid, or an aerosol.

The apparatus can further comprise a driving force on the fluid to allow at least part of the permeation components to pass through the permeable membrane and reach the permeation side of the separation membrane. In some embodiments, the driving force is selected from the group consisting of a pressure difference, a concentration difference, or a temperature difference.

Any permeable membrane that can be fouled by concentration polarization can be used with the disclosed apparatus. For example, the membrane can be a nanofiltration membrane, ultrafiltration membrane, microfiltration membrane, or reverse osmosis membrane. Suitable permeable membranes are generally constructed of a polymer selected from the group consisting of cellulose acetate, polysulfone, polyether sulfone, polyacrilonitrile, polyvinylidiene fluoride, polypropylene, polyethylene, polyvinyl chloride, polyvinyl alcohol, polyamide, and polyester.

Also disclosed is a method for separating permeate from retentate in a fluid that comprises loading the fluid into the feed chamber of the membrane separation apparatus disclosed herein and applying a driving force on the fluid to allow at least part of the permeate to pass through the permeable membrane and reach the permeation side of the membrane.

Also disclosed is a method for inhibiting or preventing concentration polarization of a permeable membrane used in membrane separation. The method comprises positioning at least one electrode at the fluid boundary layer of the permeable membrane, and supplying an AC voltage less than 25 V, including between 0.5 and 10 V, to the electrode. The disclosed method can enhance permeate flux of the membrane by at least 5%, 10%, 20%, 30%, 40%, 50%, 60%, 70%, 80%, 90%, or 100%.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A to 1D are cross-sectional schematics of embodiments of a membrane filtration system using a low energy method to reduce concentration polarization.

FIGS. 2A and 2B are partial cross-sectional views of embodiments of a pressure driven disk tube reverse osmosis system using a low energy method to reduce concentration polarization.

FIG. 3 is a schematic of an experimental design for identification of concentration polarization at low applied electric potentials.

FIG. 4 is an image of an embodiment of a low energy pressure driven reverse osmosis system.

FIG. 5 is an image of an embodiment of a partition disk for use in a low energy pressure driven reverse osmosis system that was gold plated in order to render it conductive.

FIG. 6 is a graph showing concentration flux (nM/min*m²) as a function of bias (mV) for potassium phosphate buffer (pH 7±0.2) at 1 mM (square) and 0.2 mM (diamond) with 10 nm membranes. At 1 mM, all three polarization regimes (ohmic, limiting and overlimiting) can be seen, while only the ohmic and limiting regimes were identified at 0.2 mM.

FIGS. 7A and 7B are illustrations of a concentration boundary layer formed by concentration polarization on a membrane surface. FIG. 7A shows the development of the concentration polarization boundary layer for cross-flow over the membrane, with the permeate passing through the membrane as shown. FIG. 7B depicts the process of membrane fouling that is initiated by concentration polarization. The cake layer is a dense particle layer adjacent to the membrane surface. This layer can irreversibly foul the membrane as the polarization layer remains over the membrane surface.

### DETAILED DESCRIPTION

Disclosed are membrane separation devices and methods of using the devices that involve loading a fluid containing retention components and permeation components at a separation side of a permeable separation membrane. Also disclosed are methods that can significantly enhance filtration efficiency and prolong the useful life of a permeable membrane used in membrane separation. These devices and methods generally involve positioning at least one electrode at the fluid boundary layer of the permeable membrane, and supplying an AC voltage less than 25 V to the electrode.

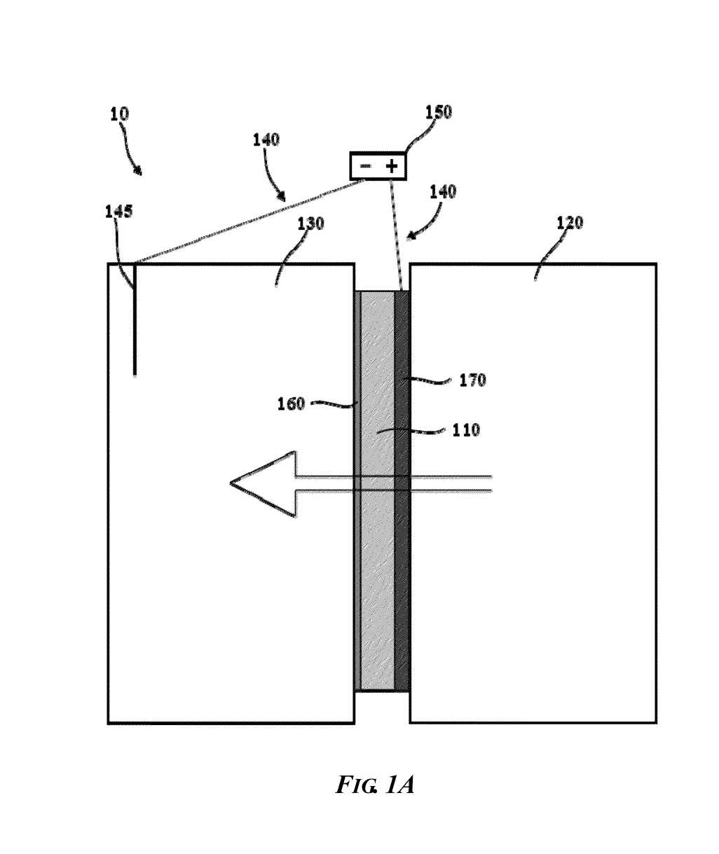

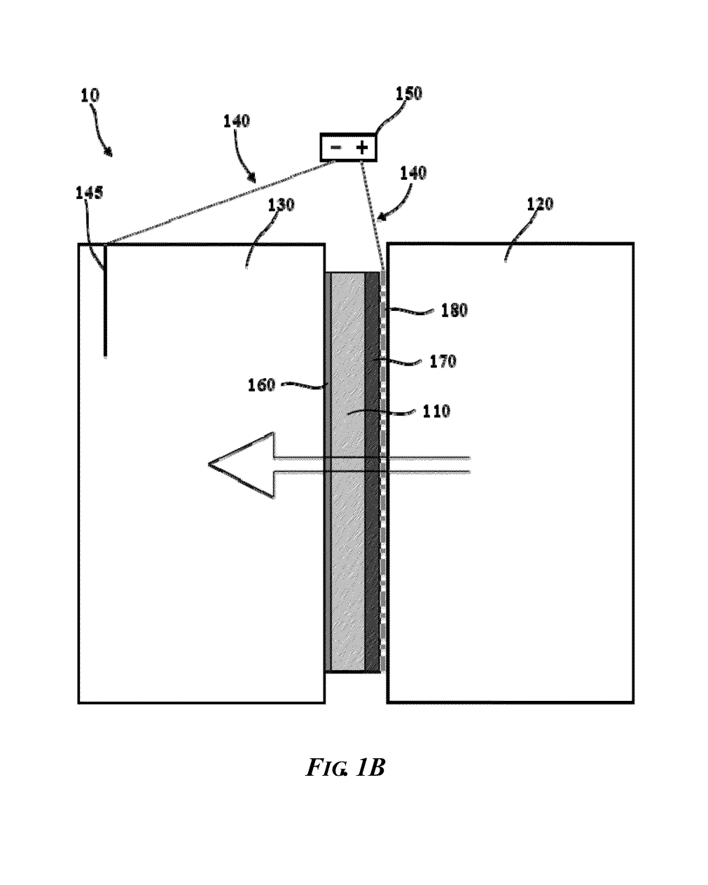

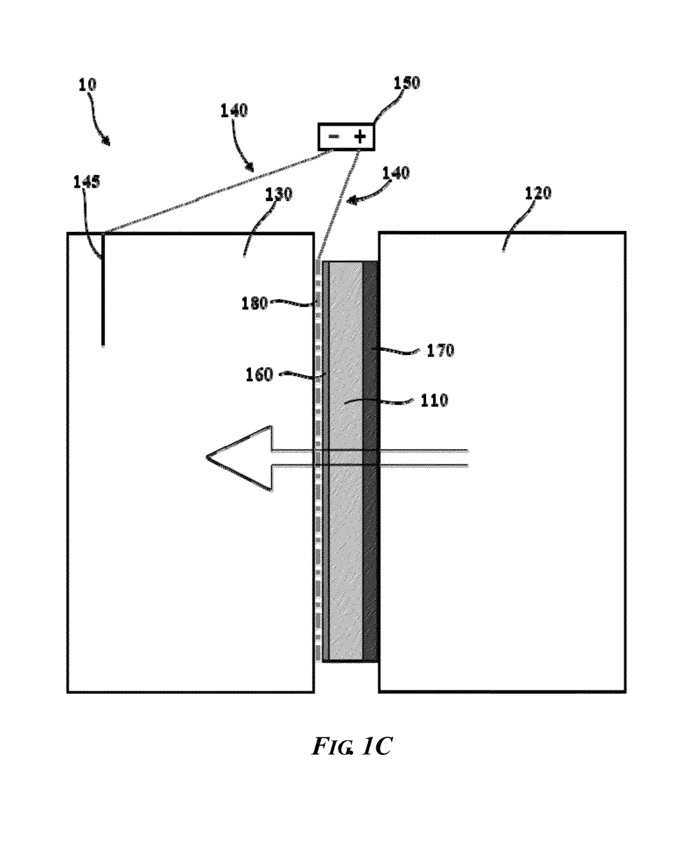

Referring now to the figures, FIGS. 1A to 1D are cross-sectional schematics of embodiments of a membrane separation system (10) using a low energy method to reduce concentration polarization. The membrane separation system (10) generally involves a loading fluid/feed chamber (120) and a permeate chamber (130) separated by a permeable membrane (110). The membrane (110) is show sandwiched between a dense rejecting layer (170) on the feed side and a supporting layer (160) on the permeate side. An AC voltage source (150) is attached by electrical connections (140) to an anode and cathode in the system to generate an electrical field as described in detail below. In some implementations, the electrical field is applied across the membrane (110) as shown in FIGS. 1A, 1B and 1D.

The AC voltage source (150) is configured to apply a voltage signal between an anode and a cathode. Optionally, the AC electrical voltage (150) can be configured to apply a voltage signal with a magnitude less than or equal to approximately 25 V. Alternatively, the AC voltage source (150) can be configured to apply a voltage signal with a magnitude between approximately 10 V and 0.5 V. Alternatively or additionally, the AC voltage source (150) can be configured to apply a voltage signal with a magnitude between approximately 6 V and 0.5 V. Alternatively or additionally, the AC voltage source (150) can be configured to apply a voltage signal with a magnitude between approximately 4 V and 0.5 V. Optionally, the AC voltage source (150) can be configured to apply a voltage signal with a magnitude less than or equal to approximately 1 V such as approximately 0.5 V, for example. It should be understood that the approximate voltages described above are only examples and that other voltages or voltage ranges can be used. It should also be understood that power increases proportional to voltage squared and that using lower voltages can result in substantial power savings.

Additionally, the voltage signal can optionally oscillate at a predetermined frequency. In other words, the AC voltage source (150) can be configured to apply a voltage signal with a predetermined frequency. The predetermined frequency can be related to the diffusion time scale of the membrane (110), which is dependent on a number of factors including, but not limited to, the membrane characteristics, the ion concentration, and the fluid velocity. In some embodiments, the diffusion time scale is about 1 ms to about 100 μs. Therefore, the predetermined frequency can optionally be in a range between 1 kHz and 10 MHz. An example AC electrical source used in some of the examples provided herein is the 3390 ARBITRARY FUNCTION GENERATOR &WAVEFORM FUNCTION GENERATOR of KEITHLEY INSTRUMENTS, INC. of CLEVELAND, Ohio.

As described above, the AC voltage source (150) is configured to apply a voltage signal between an anode and a cathode, for example, between a primary electrode and a counter electrode as shown in FIGS. 1A-1D. The primary electrode can optionally be provided on the membrane (110). Alternatively, the primary electrode can be provided in close proximity to (or near) the membrane (110). When the primary electrode is provided within a fluid boundary layer in the vicinity of the membrane (110), it is in close proximity to the membrane (110) as used herein. It should be understood that the fluid boundary layer is a layer of fluid in the immediate vicinity of the membrane (110). The thickness of the fluid boundary layer (e.g., from the membrane (110) to a point in the feed or permeate fluid having a free stream velocity) can be calculated or estimated by any means known in the art. It should be understood that the thickness of the fluid boundary layer is dependent on a number of factors including, but not limited to, velocity of the fluid flowing over the membrane (110) (e.g., the feed flow or the permeate flow). For example, the fluid boundary layer can have a thickness of approximately less than or equal to 100 μm, and the primary electrode can be provided within 100 μm of the surface of the membrane (110) within the fluid boundary layer. According to the implementations described herein, it is possible to reduce the concentration polarization using lower voltages.

In some implementations, the primary electrode is provided on the separation/feed side of the membrane (110) at the fluid boundary layer. In other implementations, the primary electrode is provided on the permeate side of the membrane (110) at the fluid boundary layer. In yet other implementations, the primary and counter electrodes are provided on the feed side and permeate side of the membrane (110) at the fluid boundary layers, respectively. The phrase “at the fluid boundary layer” includes embodiments where any portion of the electrode is within the fluid boundary layer. For example, the electrode can be wider than the fluid boundary layer but still be “at” the fluid boundary layer.

Optionally, at least a portion of the fluid boundary layer can have a substantially higher concentration of the substances being removed by the membrane (110) as compared to the concentration of fluid flowing over the membrane (110). The thickness of the portion of the fluid boundary layer having a substantially higher concentration is dependent on the mass transfer characteristics of the membrane (110) including, but not limited to, membrane flux and fluid velocity.

In the embodiment shown in FIG. 1A, the membrane (110) is plated with a conductive material (e.g., gold) and acts as the primary electrode (anode or cathode). A counter electrode (145), such as a gold wire, can be present in the permeate chamber (130). In the embodiments shown in FIGS. 1B to 1D, a conductive mesh (180) is used as the primary electrode instead of plating the membrane (110), either on the feed side (FIG. 1B) or the permeate side (FIG. 1C). The conductive mesh (180) can optionally be provided at the fluid boundary layer on the feed side (FIG. 1B) or the permeate side (FIG. 1C) of the membrane (110). In FIG. 1D, a conductive mesh (180) is used as both the primary and counter electrode by placing on both the feed side and the permeate side of the membrane (110). In FIG. 1D, the conductive mesh (180) can optionally be provided at the fluid boundary layers on the feed side and the permeate side of the membrane (110), respectively.

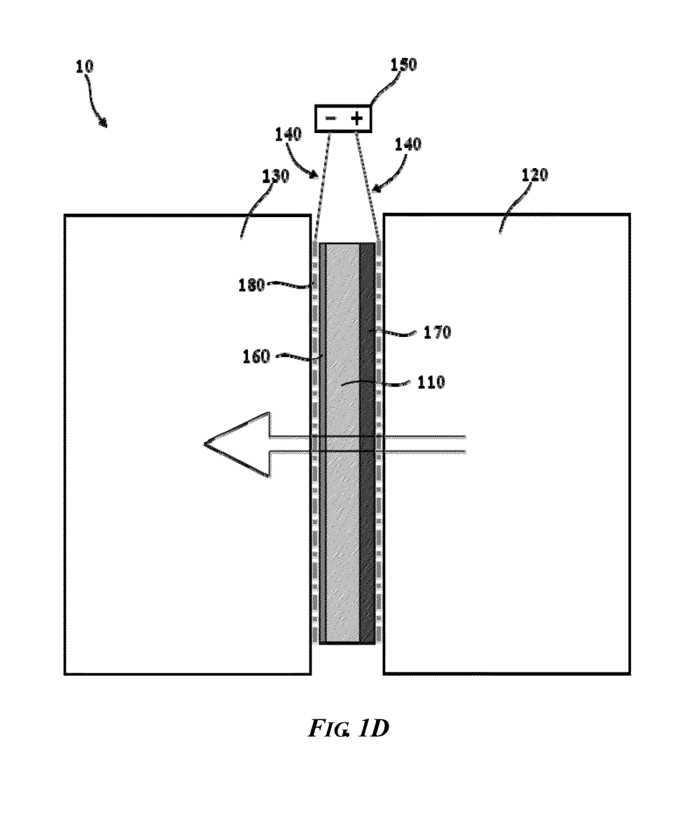

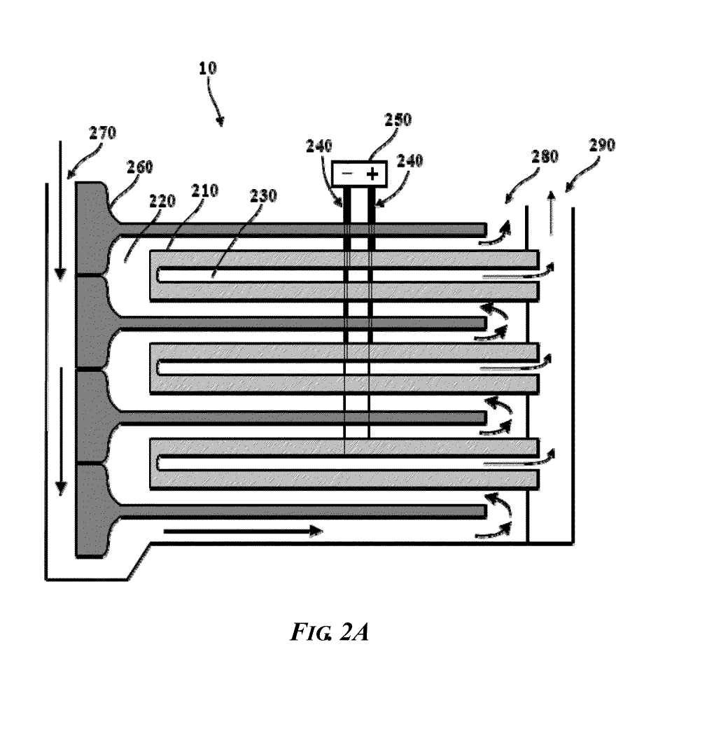

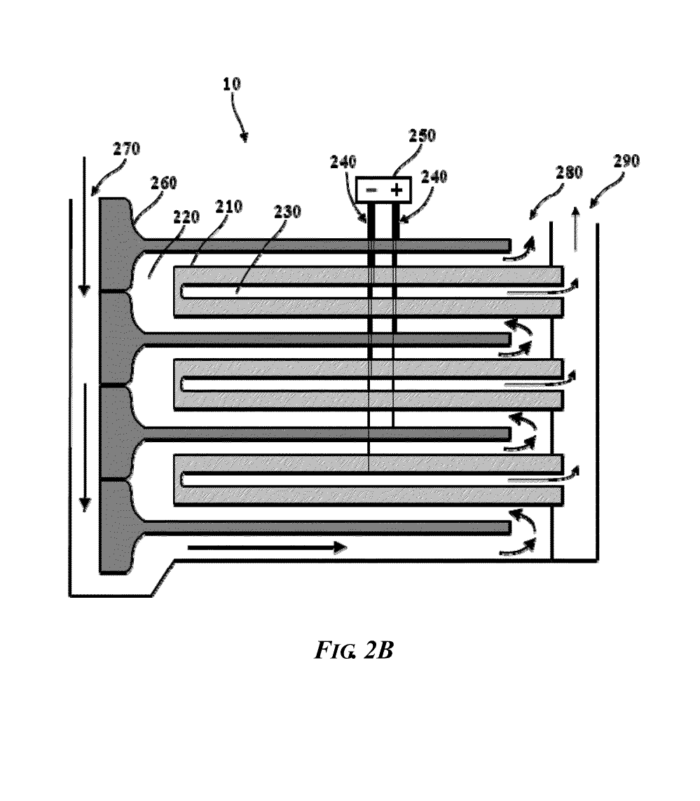

FIGS. 2A and 2B are partial cross-sectional views of embodiments of the membrane separation system (10) involving pressure driven disc tube reverse osmosis system. This system involves conductive membrane discs (210) stacked between hydraulic partition discs (260). A feed inlet (270) directs fluid into a flow chamber (220) where flow is directed up and over each membrane (210) allowing fluid to pass through the conductive membrane (210), be collected by a permeate collector (230) and released out a permeate outlet (290). The remaining fluid continues out a concentrate outlet (280). A waveform generator (250) is attached by electrical connections (240) to the conductive membrane (110) to generate an electric field across the membrane. In some embodiments, the electrical connections (240) are attached to either side of the conductive membrane (110) (FIG. 2A). In some embodiments, the partition discs (260) are rendered conductive and act as one of the electrodes (FIG. 2B).

The disclosed electrodes can be fabricated from any suitable conductive material, such as a metal (e.g., gold, platinum, palladium, titanium, or combinations thereof), metal alloy (stainless steel), metal oxide, or conductive carbon. Appropriate materials can be selected in view of a number of factors, including the nature of the solution in contact with the electrode. For example, the electrode can be fabricated so as to be resistant to corrosion. In some embodiments, the disclosed electrodes can comprise a gold electrode. In other embodiments, the electrode can comprise a metal electrode (e.g., a titanium electrode) comprising an anti-corrosive coating (e.g., a metal oxide or mixed metal oxide coating)

In some embodiments, the disclosed electrodes can comprise a conductive thin film or coating disposed on a surface of the membrane. When present as a conductive thin film or coating, the electrode can be formed so as not to block the underlying pores of the membrane (e.g., the disclosed electrodes can comprise a thickness and porosity effective to provide paths for fluid flow across the electrode). In this way, the electrode in combination with the underlying membrane can retain fluid permeability, such that they can function as a barrier for membrane separation. Electrodes of this type can be formed using a variety of suitable methods known in the art for the patterning of conductive materials on substrates. For example, the disclosed electrodes can comprise a conductive thin film or coating formed by spray deposition, electroless plating, evaporation, or the like.

The thickness of the conductive thin film or coating can be varied. In some embodiments, the disclosed electrodes can comprise a conductive thin film or coating disposed on a surface of the membrane having a thickness of less than about 1 micron (e.g., less than about 900 nm, less than about 800 nm, less than about 750 nm, less than about 700 nm, less than about 600 nm, less than about 500 nm, less than about 400 nm, less than about 300 nm, less than about 250 nm, less than about 200 nm, less than about 100 nm, less than about 90 nm, less than about 80 nm, less than about 75 nm, less than about 60 nm, less than about 50 nm, less than about 40 nm, less than about 30 nm, or less than about 25 nm). In some embodiments, the disclosed electrodes can comprise a conductive thin film or coating disposed on a surface of the membrane having a thickness of at least about 20 nm (e.g., at least about 25 nm, at least about 30 nm, at least about 40 nm, at least about 50 nm, at least about 60 nm, at least about 70 nm, at least about 75 nm, at least about 80 nm, at least about 90 nm, at least about 100 nm, at least about 200 nm, at least about 250 nm, at least about 300 nm, at least about 400 nm, at least about 500 nm, at least about 600 nm, at least about 700 nm, at least about 800 nm, or at least about 900 nm).

The disclosed electrodes can comprise a conductive thin film or coating disposed on a surface of the membrane having a thickness ranging from any of the minimum values above to any of the maximum values described above. For example, in some embodiments, the disclosed electrodes can comprise a conductive thin film or coating disposed on a surface of the membrane having a thickness ranging from about 20 nm to about 1 micron (e.g., from about 20 nm to about 500 nm, or from about 20 nm to about 200 nm).

In some embodiments, the disclosed electrodes can comprise a conductive mesh or screen positioned in proximity to the membrane (e.g., the conductive mesh or screen can be positioned such that at least a portion of the conductive screen or mesh is present at the fluid boundary layer on the feed side or the permeate side of the membrane). In certain embodiments, the disclosed electrodes can comprise a conductive mesh or screen fabricated from a metal (e.g., gold, platinum, palladium, titanium, or combinations thereof) or metal alloy (stainless steel). In particular embodiments, the disclosed electrodes can comprise a stainless steel mesh or screen.

The thickness of conductive mesh or screen can be varied. In some embodiments, the conductive mesh or screen can have a thickness of less than about 1000 microns (e.g., less than about 900 microns, less than about 800 microns, less than about 750 microns, less than about 700 microns, less than about 600 microns, less than about 500 microns, less than about 400 microns, less than about 300 microns, less than about 250 microns, less than about 200 microns, less than about 100 microns, less than about 90 microns, less than about 80 microns, less than about 75 microns, less than about 70 microns, or less than about 60 microns). In some embodiments, the conductive mesh or screen can have a thickness of at least about 50 microns (e.g., at least about 60 microns, at least about 70 microns, at least about 75 microns, at least about 80 microns, at least about 90 microns, at least about 100 microns, at least about 200 microns, at least about 250 microns, at least about 300 microns, at least about 400 microns, at least about 500 microns, at least about 600 microns, at least about 700 microns, at least about 800 microns, or at least about 900 microns).

The disclosed electrodes can comprise a conductive mesh or screen having a thickness ranging from any of the minimum values above to any of the maximum values described above. For example, in some embodiments, the disclosed electrodes can comprise a conductive mesh or screen having a thickness ranging from about 50 microns to about 1000 microns (e.g., from about 100 microns to about 750 microns).

In some embodiments, the fluid contains components capable of forming a concentration polarization layer at the separation side of the separation membrane. For example, the fluid can be a solution, a liquid-solid suspensoid, a liquid-liquid suspensoid, a sol, a gas mixture, a gas-solid suspensoid, a gas-liquid suspensoid, or an aerosol. Examples of feed fluids include liquids, gasses, and vapors. The disclosed devices and methods are suitable for treatment of water as the feed fluid, such as brackish water, seawater, waste water, and industrial water. Examples of substances that cause membrane fouling include suspended substances such as fine particles and microorganisms, oxides of metals such as iron and manganese, insoluble inorganic substances (scales) such as calcium carbonate and silica, and organic substances such as oils and polymer residues.

In some embodiments, retention components refer to any components in the fluid that can be retained at least partially by the separation membrane. Non-limiting examples include ions, particles, biomacromolecules (e.g., proteins, nucleic acids, and polysaccharides), and biomicromolecule (e.g., amino acids, nucleotides, and monosaccharides). Permeation components refer to any components in the fluid, which can at least partially permeate the separation membrane, such as one or more liquid solvents, carrier gases and components different from the retention components. In some embodiments, the retention components may form a filter cake at the separation side, and/or enter into and block membrane pores, and/or permeate the separation membrane, in addition to the formation of a concentration polarization layer.

There are two main flow configurations for membrane separation: cross-flow and dead-end filtrations. In cross-flow filtration the feed flow is tangential to the surface of membrane, retentate is removed from the same side further downstream, whereas the permeate flow is tracked on the other side. In dead-end filtration the direction of the fluid flow is normal to the membrane surface. Both flow geometries offer some advantages and disadvantages. The dead-end membranes are relatively easy to fabricate which reduces the cost of the separation process. The dead-end membrane separation process is easy to implement and the process is usually cheaper than cross-flow membrane filtration. The dead-end filtration process is usually a batch-type process, where the filtering solution is loaded (or slowly fed) into membrane device, which then allows passage of some particles subject to the driving force. The main disadvantage of a dead end filtration is the extensive membrane fouling and concentration polarization. The fouling is usually induced faster at the higher driving forces. Membrane fouling and particle retention in a feed solution also builds up a concentration gradients and particle backflow (concentration polarization). The tangential flow devices are more cost and labor intensive, but they are less susceptible to fouling due to the sweeping effects and high shear rates of the passing flow.

The most commonly used membrane separation devices are flat plates, spiral wounds, and hollow fibers. Flat plates are usually constructed as circular thin flat membrane surfaces to be used in dead-end geometry modules. Spiral wounds are constructed from similar flat membranes but in a form of a “pocket” containing two membrane sheets separated by a highly porous support plate. Several such pockets are then wound around a tube to create a tangential flow geometry and to reduce membrane fouling. Hollow fiber modules consist of an assembly of self-supporting fibers with a dense skin separation layers, and more open matrix helping to withstand pressure gradients and maintain structural integrity. The hollow fiber modules can contain up to 10,000 fibers ranging from 200 to 2500 μm in diameter. The main advantage of hollow fiber modules is very large surface area within an enclosed volume, increasing the efficiency of the separation process.

Membrane separation processes differ based on separation mechanisms and size of the separated particles. Examples of pressure driven operations include microfiltration, ultrafiltration, nanofiltration, and reverse osmosis. Examples of concentration driven operations include dialysis, pervaporation, forward osmosis, artificial lung, and gas separation. Examples of operations using an electric potential gradient include electrodialysis, membrane electrolysis (e.g. chloralkali process), electrodeionization, electrofiltration, and fuel cell. An example of an operation using a temperature gradient is membrane distillation. Microfltration and ultrafiltration are widely used in food and beverage processing (beer microfiltration, apple juice ultrafiltration), biotechnological applications and pharmaceutical industry (antibiotic production, protein purification), water purification and wastewater treatment, and microelectronics industry. Nanofiltration and reverse osmosis membranes are mainly used for water purification purposes. Dense membranes are utilized for gas separations (removal of CO₂ from natural gas, separating N₂ from air, organic vapor removal from air or nitrogen stream) and sometimes in membrane distillation. The later process helps in separating of azeotropic compositions reducing the costs of distillation processes.

The pore sizes of technical membranes are specified differently depending on the manufacturer. One common form is the nominal pore size. It describes the maximum of the pore size distribution and gives only a vague statement about the retention capacity of a membrane. The exclusion limit or “cut-off” of the membrane is usually specified in the form of NMWC (nominal molecular weight cut-off, or MWCO, Molecular Weight Cut Off, Unit: Dalton). It is defined as the minimum molecular weight of a globular molecule which is retained by the membrane to 90%. The cut-off, depending on the method, can by converted in the so-called D90, which is then expressed in a metric unit. In practice, the MWCO of the membrane should be at least 20% lower than the molecular weight of the molecule that is to be separated.

Filter membranes are divided into four classes according to their pore size. Pores greater than 0.1 μm (>5000 kDa) are used in microfiltration; pores between 2-100 nm (5-5000 kDa) are used in ultrafiltration; pores between 1-2 nm (0.1-5 kDa) are used in nanofiltration; and pores less than 1 nm (<100 Da) are used in reverse osmosis.

Examples of permeable separation membranes include reverse osmosis (RO) membranes, nanofiltration (NF) membranes, ultrafiltration (UF) membranes, and microfiltration (MF) membranes. Examples of MF/UF membrane materials include cellulose acetate, polysulfone, polyether sulfone, polyacrilonitrile, polyvinylidiene fluoride, polypropylene, polyethylene, and polyvinyl chloride. Examples of reverse osmosis membrane materials for water treatment include cellulose acetate, polyvinyl alcohol, polyamide, and polyester. Membranes can also be formed from metals, glasses, or ceramics. The membrane may be a composite membrane made of any combination of these materials laminated together. Important membrane material properties include high porosity, narrow pore distribution or sharp MWCO, high polymer strength (elongation, high burst and collapse pressure), good polymer flexibility, permanent hydrophilic character, wide range of pH stability, good chlorine tolerance, and low cost. Membranes are generally manufactured by spinning (capillary), casting (flat sheet), extrusion and stretching (capillary, flat sheet), and thermally induced phase separation (TIPS).

In some embodiments, the driving force may be produced by any suitable mode, such as pressure difference, concentration difference, potential difference, or temperature difference. In some embodiments, the concentration polarization layer is formed at the separation side of the separation membrane under the gravity of a fluid per se. In this case, no additional means is used in said membrane separation equipment for exerting a driving force on said fluid. In other embodiments, an additional means is used for exerting a driving force on said fluid to form a concentration polarization layer at the separation side of the separation membrane. The driving force may be produced by any suitable means, such as a means causing a pressure difference, a concentration difference, a potential difference, or a temperature difference. In particular, a positive pressure can be exerted on the separation side of the membrane or a negative pressure can be exerted on the permeation side of the membrane by a known means to produce a pressure difference. For example, positive pressure may be produced using pump, positive pressure fluid or centrifugal force at the separation side, while negative pressure may be produced by a vacuum means at the permeation side. A concentration difference may be produced by means of evaporation, adsorption or dilution using a known means. A potential difference may be produced by exerting a direct current between two sides of a membrane using a known means to make the charged ions or molecules permeate the membrane and migrate to the electrodes at two sides, thereby forming a concentration polarization boundary layer at each side of the membrane. A temperature difference may be produced by a means capable of controlling the fluids of both sides at different temperatures, such as heater, cooler or heat exchanger.

The term “membrane separation” refers to an operation or process for reducing or removing one or more components in a raw material using a selective permeation membrane to increase the proportion or concentration of other one or more components in the raw material.

The term “concentration polarization” refers to a phenomenon that a separation membrane selectively allows some components in a raw material to pass through but other components to be retained, which results in the enriching of the retention components near to the membrane surface of separation side to form a concentration gradient from membrane surface to raw material bulk phase. In theory, any boundary layer in which a concentration gradient of retention component from membrane surface to raw material bulk phase exists may be called “concentration polarization layer”.

A number of embodiments of the invention have been described. Nevertheless, it will be understood that various modifications may be made without departing from the spirit and scope of the invention. Accordingly, other embodiments are within the scope of the following claims.

### EXAMPLES

### Example 1

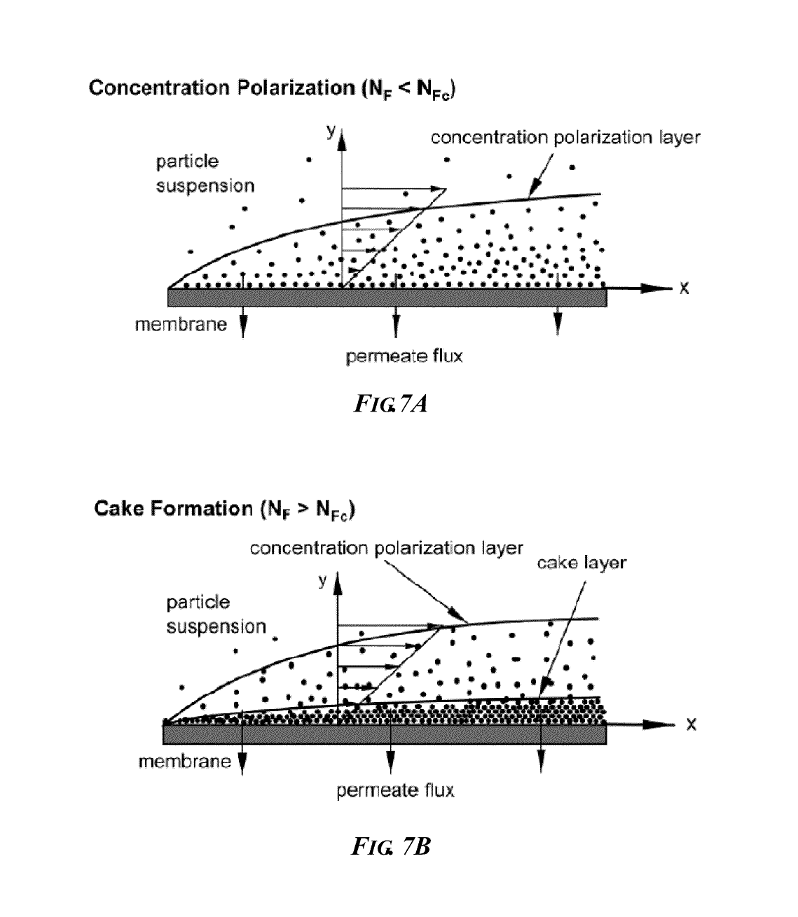

The main energy requirement of reverse osmosis membrane desalination is consumed by building the pressure necessary through electrically driven pumps to force water through the membrane, which rejects >99% of salt ions for commercial membranes, with energy consumption for common desalting methods summarized in Table 1. Although seawater osmotic pressure is typically 25 bar, higher operating pressures are required to achieve practical flows as well as balance the increasing salinity of the feed water as clean water is collected and overcome concentration polarization across the membranes as the desalination process progresses. This is caused by the prevalence of the convective flux towards the membrane surface over the back diffusion to the bulk. As membrane separations develop, concentration gradients form at the membrane surface as a result of the rejected feed components building up near the membrane on the feedwater side. This initial membrane fouling is known as concentration polarization, which forms a higher concentration boundary layer at a membrane surface as illustrated in FIG. 7A.

TABLE 1
Energy consumption and capacity for various commercially implemented
desalination methods

| | | Multi-Effect | |
|---|---|---|---|
| | | Distillation/ | |
| | Multi-Stage | Thermal Vapor | Reverse |
| Process | Flash | Compression | Osmosis |
| Heat Consumption (kJ/l) | 290 | 145-390 | — |
| Electricity Consumption | 10.8-18 | 5.4-9 | 6.5-25.2 |
| (kj/l) | | | |
| Total Energy Consumption | 300.8-308.8 | 150.9-399 | 6.5-25.3 |
| (kJ/l) | | | |

The concentration boundary layer causes flux impediment due to the rise in local concentration of species. This, in turn, leads to an increased local osmotic pressure at the membrane surface, which causes a decrease in the effective driving pressure. As the fouling continues to develop, particles can adhere to the membrane surface causing scaling, which occurs when solid phase precipitates out of the solution, or biofilm formation. In addition to flux impediment, biofilms can act as a source of permeate contamination. This denser, more impeding layer can be termed a cake or gel layer as shown in FIG. 7B.

As the cake or scale layer continues to build, it can become permanently attached to the membrane surface causing irreversible fouling that diminishes the flux through the membrane, which cannot be recovered even after the membrane is cleaned. Concentration polarization initiates cake layer formation; with ions and non-fouling macromolecules, the polarization layer behaves as if there is an additional or virtual membrane at the physical membrane surface. The higher osmotic pressure through the coupled virtual and real membrane system creates a larger requirement for the driving force of the separation process to overcome, thereby decreasing the separation efficiency.

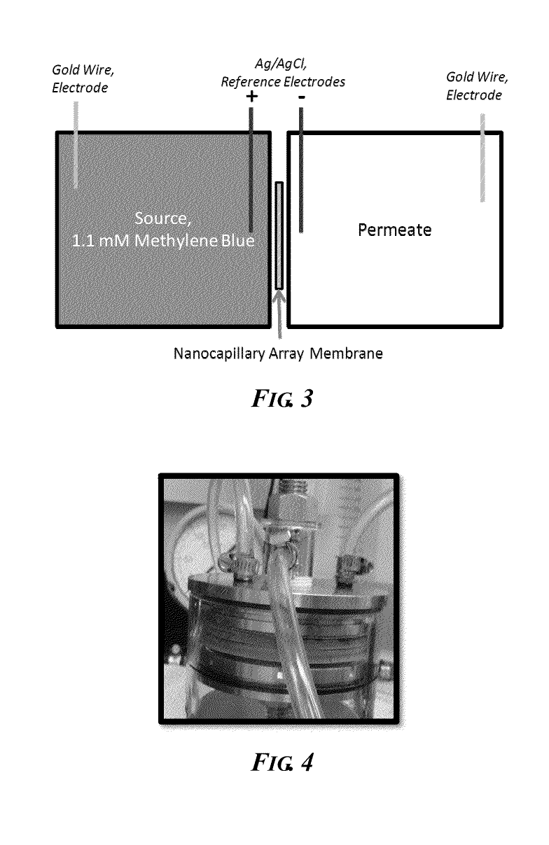

Experimental efforts were directed towards identification of concentration polarization regimes at low voltages (<1 V). Concentration polarization identification experiments were performed using track etched, PVP (or polyvinyl pyrolidone) coated polycarbonate membranes (diameter 25 mm) with nominal pore sizes 10 nm, 50 nm, and 100 nm (GE Osmonics). These membranes were used as model membranes to demonstrate the operational physics. Membranes were pre-treated in DI water for 48 hours and working buffer solution for 4 hours immediately prior to experiment following a previously established protocol. Current measurement and potential application was carried out using a Gamry Reference 600 potentiostat in a four electrode setup. Potassium phosphate buffer (pH 7±0.2) in concentrations 10 mM, 1 mM, and 0.2 mM was prepared with Millipore 18.2 MΩ deionized water and monobasic and dibasic potassium phosphate (Sigma Aldrich, USA). The buffer solution was chosen to keep the pH constant and use the salt solution as a model solution in laboratory experiments. Permeation experiments were carried out in a custom cast acrylic permeation cell (FIG. 3) with 500 mL solution in each side. The permeation cell was placed in an earth grounded Faraday cage.

The source side of the permeation cell contained an added 0.14 mM Methylene Blue solution from Sigma-Aldrich. Current was recorded throughout the experiment and equal samples of solution were extracted from both sides of the permeation cell at 0, 8, 15, 30, 45, and 60 minutes after thorough stirring of the sides at those times to ensure a uniformly mixed solution. The reference electrodes used were Ag/AgCl reference electrodes connected to a high impedance input to the potentiostat while both the working and counter electrodes were 1 mm diameter high purity gold wires (Alfa Aesar) which had been cleaned using an SC-1 cleaning process. Methylene blue is positively charged for the experimental conditions and absorptivity of each sample was measured with a Thermo-Scientific Evolution 300 UV-Vis at 665 nm. Concentration and absorptivity are related by the Beer-Lambert law as shown by the following equation 1:

A=∈cl (1),

where A is the absorptivity, ∈ is the molar absorptivity, c is concentration, and l is path length of light. From this equation, it can be seen that absorbance is linear with concentration for fixed molar absorptivity and path length. Thus, solutions of known concentration were prepared in the concentration range of expected values with a margin for model error; this was repeated three times to ensure repeatability. A linear fit was applied to this data for each of the potassium phosphate buffer concentrations and absorptivity values were converted back to concentration with this method.

In addition to identifying regimes where CP onset occurs, CP mitigation experiments were carried out using forward osmosis and reverse osmosis membranes in several different configurations. Polyamide-based forward osmosis (FO) membranes provided by Porifera (California, USA) were electrolessly gold plated to render the membrane conductive. Hydraulic Technology Innovations (HTI) also provided cellulose triacetate based FO membranes from their cartridge product, which were also electrolessly gold plated. Flux experiments were performed by using a custom permeation cell (FIG. 1A), DI water as the feed solution and 1.5 M NaCl as the feed solution using NaCl (Fisher Scientific, USA) and Millipore DI water (18.6 MΩ). The permeation cell began with 400 mL of feed and draw solutions on their respective sides and the experiment was run for 8 hours. The control case used unplated Porifera membranes while the experimental case used plated Porifera membranes where the membrane was used as the electrode. A waveform generator (Keithley 3390) was used to apply an electrical field between the gold wire and the conductive membrane.

For an unplated membrane, an additional configuration to this setup is to add a conductive mesh on the rejecting layer side or the supporting layer side of the membrane as the electrode as well as on both sides of the membrane to serve as both electrodes thus eliminating the need for the gold wire. The schematics for these are shown in FIGS. 1B-1D. The anode (or cathode) can be formed with conductive mesh and a gold wire used as the counter electrode. Another configuration is to use a piece of conductive mesh on each side of the membrane as the anode and cathode. Each of these electrical configurations proposed could yield potential benefits for the system.

Electrical connections were initially attempted by soldering onto the membrane after the plating process was complete, however, the solder connection broke away after an initial eight hour experiment was performed. Several types of electrical connections were then explored including a conductive epoxy (Chemtronics, USA) and solder both with and with an acrylic overcoat (Chemtronics, USA). The conductive epoxy both with and without overcoat was found to be more reliable as a connection due to its greater reliability in keeping the electrical connection viable.

In addition, a low energy pressure driven reverse osmosis was also developed. The base of this design is the Pall Disc Tube™ Reverse Osmosis module. Working from the Pall design, which was chosen because this design encourages turbulent flow, therefore already minimizing fouling and concentration polarization, the design in consideration incorporates a conductive membrane, spacer, mesh or a combination of those. In addition, an electrical connection port was added to the lid of the pressurized chamber to allow for power supply connections.

An example system used for proof of concept is pictured in FIG. 4. This system produces desalinated water from test seawater made of tap water and Instant Ocean, a commercially available aquatic sea salt. The electrical connection port is directly behind the tie rod, while the clear acrylic casing allows for clear flow visualization during testing.

An alternative configuration to add an electrode to the system other than electrifying the spacer/supporting meshes as shown in FIGS. 1B to 1D would be to render the partition disks conductive through the same electroless plating process used for the membranes and add an electrical connection to it. An example of such a partition disk is shown in FIG. 5, which was electrolessly gold plated to make it suitable for use an electrode in the system.

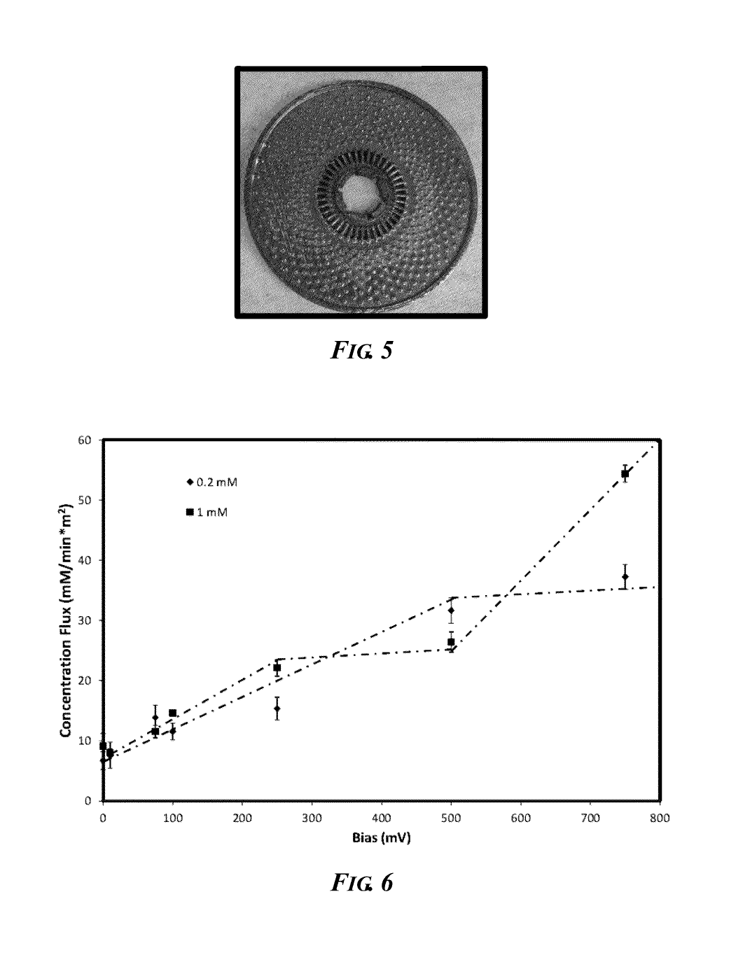

Using the experimental method described above for CP regime identification with methylene blue, the concentration gradient (concentration/time) at each bias, buffer, and pore size was found. CP polarization regimes could then be identified as shown in FIG. 6. Here methylene blue, a marker molecule described by its concentration flux, was used to monitor the movement of the major charge carriers (potassium phosphate buffer) in the system. From FIG. 6, it can be seen for the 1 mM case with 10 nm membranes, clear ohmic, limiting and overlimiting regimes developed for electrokinetic flow through the NCAM. For the 0.2 mM case with 10 nm membranes, ohmic and limiting regimes were observed, while the overlimiting regime was not observed for the voltages tested.

The largest challenge in using membranes of about 6 to 12″ sheets (˜15 to 30 cm) was to ensure uniformity of the metallic layers, which need to be thin and porous to not alter membrane selectivity or flux but provide an avenue for attachment of external electrical connections for controlling membrane surface potentials. The challenges arose due to chemical stabilization of these membranes (usually in glycerol) before use and the requirement that these membranes remain soaked once wetted to maintain pore structure integrity and thus selectivity of the membrane.

A process was developed to yield uniform metal coatings on large area membranes (˜30 cm sheets) with low surface electrical resistance. The process improvements including temperature control (plating bath at 4° C.) and tighter control on plating bath pH (10+/0.3) led to consistent surface metallization approximately 10Ω of surface resistance achieved on the membrane.

Next, an electrical connection to the membranes was needed to use the metallic layer as an electrode to control membrane surface potential but the corrosive nature of the artificial seawater used for testing of the metalized membranes led to several failures. Following several, a final solution to this problem was using a thicker, more corrosion resistant wire (28 AWG, 304 SS) attached to the membrane with the conductive epoxy, where the epoxy site was covered with a protective overcoat (Circuitworks, CW3300G).

For the 1000 mm² FO crossflow cell, the first scaled-up system from the desktop version from the ˜100 mm² system, the cathode was designed to be a metal spring loaded pin that was soldered into a set screw, while the anode was chosen to be a stainless steel wire (28 AWG, 304 SS) separated from the metallized membrane surface by a polymer mesh to avoid a short in the system. Spring loaded electrical connectors were not used for both the anode and cathode to avoid an electrical short caused by putting both electrical connections on the metallized membrane surface.

These connections were attached to the power supply by attachment to the metal fittings used to attach the tubing for flow to/from the pump. In addition to providing separation between the membrane and the counter electrode, the mesh in the both of these systems acted to reduced external concentration polarization, while having little effect on internal concentration polarization.

Forward Osmosis Testing Results

Forward osmosis testing of the CP mitigation method proceeded in three stages. The first was in a quiescent, desk-top permeation cell (FIG. 1A) which allowed for proof of concept testing and troubleshooting in a relatively simple system (˜100 mm²). The second stage was testing in a 1000 mm² crossflow cell, to verify that CP mitigation method with scaling the size up by nearly an order of magnitude. Finally a crossflow system of membrane area up to 13650 mm² was tested for the effects power consumption and area scaling with a further increase in system size by an order of magnitude.

In the quiescent permeation cell (FIG. 1A), the selective side of the membrane faces the feed solution while the supportive side faces the draw solution. The metallized membrane was used as a cathode and a gold wire (1 mm diameter, Alfa Aesar, 99.9%) was used as the anode. Permeation experiments were performed for 8 hours with 1.5 M NaCl as a draw solution and DI water as the feed solution, results are presented in Table 2.

TABLE 2
Results of first applied bias testing on commercial FO membranes
(HTI, Inc.)

| Membrane | Bias | Frequency | Flux (L/m²h) | % Difference |
|---|---|---|---|---|
| HTI cartridge | 0 | 0 | 6.9 | |
| Plated HTI cartridge | 500 mV | 1 kHz | 9.8 | 42% |

The applied bias on the membrane surface allowed a 42% higher flux to be achieved than the unmetallized membrane. The membranes used were commercial HTI cartridge membranes, which is a cellulose triacetate with embedded polyester screen mesh. At present, we are exploring several potential hypotheses to explain the data trends observed. The driving force of FO membranes is the osmotic pressure gradient, which drives water transport through the membrane using a solution of higher osmotic concentration on the product side. For the quiescent cell, Fick's first law of diffusion (Eqn. 2), describes the flux of component i in a system with a concentration gradient.

$${J}_{i} = - {D}_{i} \frac{d {c}_{i}}{d x} , \qquad ( 2 )$$

where Jᵢ is the flux of component i, Dᵢ is the diffusion coefficient of the component through the solvent, and

$$\frac{d {c}_{i}}{d x}$$

is the concentration gradient over the distance of interest. Equation (2) does not, account for the membrane itself as the flux predicted by this equation would be the same no matter what membrane was used. Hence, for a membrane separation, a factor accounting for the membrane used must be added to more accurately describe the flux through the system (Eqn. 3).

Jᵢ=Aσ(Δπ−ΔP) (3),

where A is the permeability constant of the solvent of interest through the membrane, σ is the rejection coefficient (0 for no rejection, 1 for perfect rejection), ΔP is an applied pressure (usually zero in FO systems), and Δσ is the osmotic pressure difference across the membrane, which is a function of the concentration across the membrane (Eqn. 4).

Δπ=ΔMRT (4),

where ΔM is the difference in solution molarity (concentration) on either side of the membrane, R is the universal gas constant, and T is the temperature of the solution. While determination of the osmotic pressure might seem like a straightforward calculation, in a forward osmosis separation, concentration polarization an increased concentration on the feed side and a decreased concentration on the draw side. The increase in flux shown in Table 3 suggests that the application of the electric field either changes A the permeability of the solvent through the membrane (i.e. the membrane resistance or structure), or Δπ, the effective osmotic pressure seen at the membrane surface is reduced due to a reduced concentration difference between the concentration at the membrane surface and the bulk or the electric field on the membrane is an additional driving force on the flow, which can be expressed in the ΔP term.

The purpose of moving to crossflow testing for step-by-step scaling up in size was to evaluate the efficacy of our CP mitigation method for implementation in an eventual prototype system. A 1000 mm² testing cell was designed and attached to a mass data acquisition device (Ohaus ExplorerPro) and waveform generator (Keithley 3390).

TABLE 3
FO crossflow testing results using HTI (Scottsdale, AZ) FO membranes
43,500 ppm NaCl as the draw solution and 32,000 ppm NaCl as the feed
solution. Here the 10 kHz frequency gave the greatest flux enhancement.

| Bias | Frequency | Flux (L/m²h) | % Enhancement |
|---|---|---|---|
| 0 | 0 | 1.1 | |
| 3 V | 1 kHz | 1.1 | 0.2% |
| 3 V | 10 kHz | 1.4 | 25.7% |
| 3 V | 100 kHz | 1.3 | 18.4% |
| 3 V | 1 MHz | 1.3 | 22.5% |

Testing with the feed and draw solution concentrations to test seawater conditions and to imitate the likely system level implementation, shows that at the 10 kHz frequency achieved the highest flux of the frequencies investigated, with a 25.7% enhancement over the unbiased case in Table 3. This suggests that the enhancement mechanism is not a function of bulk concentration or bulk osmotic pressure as several other concentration conditions were expected for the quiescent cell and the crossflow cell; however, the magnitude of enhancement potentially is a function of these conditions. To estimate the power consumption, additional measurements were conducted and are summarized in Table 4.

The flux enhancement was clearly dependent on the applied frequency of the bias on the membrane surface as well as the individual membrane itself. In a recent report using electrochemical impedance spectroscopy to investigate the properties of FO membranes in solution with and without transport suggests that the conductance of HTI membranes is dependent on frequency, and furthermore the conductance of the membrane significantly increases in the range of 100-1000 Hz.

Next, a large scale response of applied bias and frequency was tested for the HTI membranes to evaluate power consumption as a function of product water volume as well as investigate the consistency of the net value of the membrane and CP resistance in the system. Testing was expanded from 2 to 8 V throughout the tested frequency range of 1 kHz to 1 MHz. As the magnitude of the applied potential increases, the power consumption per amount of product water produced increase as well, ranging from 29.7 Wh/gal to 1648.1 Wh/gal. For an applied AC field, power consumption can be calculated as shown in Eqn. 5.

$${P}_{calc} = \frac{{V}_{RMS}^{2}}{{R}_{net}} , \qquad ( 5 )$$

where P_{calc} is the calculated power consumed, V_{RMS} is the root mean square of the applied voltage, and Rₙₑₜ is the net resistance of the membrane and the polarization layers on each side of the membrane.

TABLE 4
Continued applied bias testing of 1000 mm2 crossflow FO cell with the
power consumption expressed as Wh/gal produced water in the system.

| | | | P_{calc} from Rₙₑₜ | |
|---|---|---|---|---|
| Bias (V) | Frequency | Pₘₑₐₛ (Wh/gal) | (Wh/gal) | P_{calc}/Pₘₑₐₛ |
| 8 | 1 kHz | 1589.6 | | |
| 8 | 10 kHz | 1184.0 | | |
| 8 | 100 kHz | 1203.9 | | |
| 8 | 1 MHz | 1648.1 | | |
| 6 | 1 kHz | 610.7 | 894.2 | 1.5 |
| 6 | 10 kHz | 647.2 | 666.0 | 1.0 |
| 6 | 100 kHz | 356.5 | 677.2 | 1.9 |
| 6 | 1 MHz | 549.0 | 927.1 | 1.7 |
| 4 | 1 kHz | 273.6 | 397.4 | 1.5 |
| 4 | 100 kHz | 263.5 | 301.0 | 1.1 |
| 4 | 1 MHz | 340.3 | 412.0 | 1.2 |
| 2 | 10 kHz | 29.7 | 74.0 | 2.5 |
| 2 | 100 kHz | 31.1 | 75.2 | 2.4 |
| 2 | 1 MHz | 55.5 | 103.0 | 1.9 |

The results of Table 4 show that throughout the tested 2 V to 8 V applied bias with frequency range of 1 kHz to 1 MHz, the power consumption per volume of product water produced increase as well, ranging from 29.7 Wh/gal to 1648.1 Wh/gal. Beyond a 6 V applied potential the energy consumption is too high likely due to significant electrolysis adding Faradiac impedances. Therefore, no calculations for power were explicitly conducted. These experiments further confirm that the membrane resistance or the CP resistance to the flow is being changed by the electric field.

From Table 4 it can be seen that the energy consumption of the system does not scale linearly with the applied voltage, which suggests that membrane resistance and/or CP resistance exhibit non-linear behavior when these conditions are compared. In order to further evaluate the membrane area scaling, two more systems were evaluated one with a membrane area of 1950 mm² and a second one with total membrane area reaching ˜13,650 mm² with the results summarized in Table 5.

TABLE 5
Area scaled testing of the FO crossflow membrane system with Porifera
FO membranes. Note the drop in energy requirement, which is as low as
28.2 Wh/gal for the cell of 13650 mm² area and as high as 109.7 Wh/gal
for the cell of 1950 mm² area. The Pcalc value shows that the resistance
of the system does not display a linear response to area, consistently over
predicting the Pmeas by 2.8-3.7 times.

| | | Pₘₑₐₛ | Cell Area | P_{calc} from | |
|---|---|---|---|---|---|
| Bias (V) | Frequency | (Wh/gal) | (mm²) | Rₙₑₜ (Wh/gal) | P_{calc}/Pₘₑₐₛ |
| 2 | 1 kHz | 96.7 | 1950 | | |
| 2 | 10 kHz | 106.9 | 1950 | | |
| 2 | 100 kHz | 109.7 | 1950 | | |
| 2 | 1 MHz | 64.8 | 1950 | | |
| 2 | 1 kHz | 27.6 | 13650 | 98.9 | 3.6 |
| 2 | 10 kHz | 28.2 | 13650 | 96.7 | 3.4 |
| 2 | 100 kHz | 29.2 | 13650 | 106.9 | 3.7 |
| 2 | 1 MHz | 38.9 | 13650 | 109.7 | 2.8 |

Table 5 shows that the power consumption drops as the area increases in for the FO cell, 109.7 Wh/gal for the cell of 1950 mm² area to 28.2 Wh/gal for 13650 mm² of membrane area. Using the same method as above to calculate Rₙₑₜ and P_{calc}, it can be seen that the system does not behave linearly with respect to energy consumption and cell area. The over prediction of Pₘₑₐₛ from P_{calc} using values from the 1950 mm² cell ranged from 2.8 to 3.7 for an area increase of 7 times. Based on these trends, it can be extrapolated that the energy consumption will drop further presumably due to the current spreading over a larger area for a lower current density to introduce one of the changes to the membrane or the boundary layer (the two most likely hypotheses) and leading to a enhanced flux. However, the actual mechanisms of mitigating CP still need further investigation.

Development Challenges: RO System

The corrosive, high pressure environment of the system coupled with the requirement for an electrical connection initially posed challenges for scale-up. Development continued with a new prototype, which included spacer disks made from a low viscosity, highly durable, water resistant polymer. Initial permeate testing (Table 6) indicated that the system was not performing as designed, even though no visible system leaks could be found.

TABLE 6
Initial results of prototype IV testing show that some salt rejection is
taking place, however not enough for these types of membranes.

| | | |
|---|---|---|
| Source | 1600 | μS |
| Permeate | 1580 | μS |
| Reject | 1640 | μS |
| Flux rate permeate | 0.267 | mL/s |

The results of Table 6 show that almost no salt rejection in the permeate flow. Dye (methylene blue) testing was employed as a means of source of leak detection, which showed that dye was allowed into the membrane area near the o-rings. Further inspection revealed cracking of the spacer disks.

The concentrated areas of dye at the membrane edge confirm that the outer seal of the membrane is functioning correctly, thus revealing that the leak was at the o-ring seal. Further inspection of the spacer disks exposed cracking in the disks, since the disks had been in used for approximately 3 months, the failure was not necessarily an instantaneous failure. There was warping in the spacer disks after the 200 psi trials took place. This warping led to failure of the O-ring seals and high permeate salinity. To prevent this, new spacer disks made of acrylic were able to successfully accommodate the higher testing pressures. The requirement for an electrical connection in a highly pressurized system such an RO module was solved by adding a high pressure fitting in which the electrical connection wires were held in place by a high strength commercial epoxy.

During the testing of the high pressure electrical port for leaking, it was seen that the junction between the stranded wire and the membrane was not secure as shown by the water accumulation at the ends of the stranded wires. Given the high pressure environment and need for sealed feedthroughs, we developed a novel electrode system that used a stainless steel mesh was as a integrated spacer layer on the outside of the RO membrane.

Reverse Osmosis Testing Results

As with the FO membrane system, a broad parametric study was carried out and system performance over applied voltages of 1-10 V at frequencies ranging from 1 kHz to 1 MHz was verified including cycling potentials, changes to applied driving pressure and salinity varying from low feed salinity (˜500 ppm) to brackish water. Higher level testing was tasked to be conducted at Porifera due to the need for high pressure casings, beyond the safety set-up at OSU. Testing was performed with DOW Filmtec SW-HR30.

In an attempt to investigate the reason behind the flux enhancement, the RO membranes were imaged using a scanning electron microscope (SEM). Investigation of shows that for the membrane the bias has been applied across, the polymer strands shrink in comparison with the membrane was used without any bias applied across it. This suggests that the electrical bias process induces a structural change such as dielectric relaxation that permanently changes the membranes. Reports of dielectric relaxation of similar membranes (Filmtec NF90 membranes), showed a dielectric relaxation at 105 Hz. After the establishment of flux enhancement of the applied bias method, a sample of applied potentials and frequencies were tested in succession as shown in Table 7.

TABLE 7
Results of successive applied bias testing of RO unit with applied potential
of 1 V to 10 V with frequency range from 1 kHz to 1 MHz. Flux
enhancement is shown to be frequency dependent with 1 kHz and 10 kHz
being the most consistent favorable frequencies.

| Bias (V) | Frequency | Flux (L/m²h) | % Enhancement |
|---|---|---|---|
| 0 | 0 | 10.4 | |
| 1 | 1 kHz | 10.9 | 4.6% |
| 1 | 10 kHz | 11.1 | 6.5% |
| 1 | 100 kHz | 10.0 | −4.0% |
| 1 | 1 MHz | 10.0 | −3.5% |
| 2.5 | 1 kHz | 10.7 | 2.5% |
| 2.5 | 10 kHz | 10.7 | 2.5% |
| 2.5 | 100 kHz | 10.4 | −0.4% |
| 2.5 | 1 MHz | 10.6 | 2.0% |
| 5 | 1 kHz | 10.7 | 2.5% |
| 5 | 10 kHz | 11.0 | 6.0% |
| 5 | 100 kHz | 10.7 | 2.5% |
| 5 | 1 MHz | 10.4 | 0.4% |
| 7.5 | 1 kHz | 10.4 | −0.1% |
| 7.5 | 10 kHz | 10.1 | −2.7% |
| 7.5 | 100 kHz | 10.6 | 2.3% |
| 7.5 | 1 MHz | 10.4 | −0.1% |
| 10 | 1 kHz | 10.3 | −0.6% |
| 10 | 100 kHz | 10.9 | 5.2% |
| 10 | 1 MHz | 10.8 | 3.8% |

Flux enhancement as summarized in Table 7 suggests that frequency of the applied bias is an important factor as with FO. For all but the 7.5 V and 10 V cases, 1 kHz and 10 kHz frequency cases gave a flux enhancement of various percentages. The other frequencies tested were less consistent in the achieved flux enhancement, but all offered flux enhancement.

TABLE 8
Results of ‘set’ testing used to rule out hysteresis of applied bias testing.
A new membrane was used for each trial and a DC control case was
added. This data suggests that 10 kHz is a favorable frequency for
achieving flux enhancement.

| Bias (V) | Frequency | Flux (L/m²h) | % Enhancement | Power (W) |
|---|---|---|---|---|
| 0 | 0 | 10.5 | | |
| 1 | 0 | 10.2 | −2.8% | |
| 1 | 1 kHz | 10.5 | 0.3% | |
| 1 | 10 kHz | 11.2 | 7.2% | |
| 1 | 100 kHz | 11.2 | 7.3% | |
| 0 | 0 | 10.3 | | |
| 2.5 | 0 | 10.2 | −1.7% | |
| 2.5 | 1 kHz | 10.8 | 3.9% | |
| 2.5 | 10 kHz | 11.2 | 7.9% | |
| 2.5 | 100 kHz | 11.0 | 5.9% | |
| 2.5 | 1 MHz | 10.8 | 4.2% | |
| 0 | 0 | 10.0 | | |
| 5 | 0 | 10.2 | 2.0% | |
| 5 | 1 kHz | 10.4 | 4.4% | 0.10 |
| 5 | 10 kHz | 10.9 | 8.7% | 0.23 |
| 5 | 100 kHz | 10.6 | 6.4% | 0.23 |
| 5 | 1 MHz | 10.3 | 2.6% | 0.46 |
| 7.5 | 1 kHz | 9.8 | −1.6% | |
| 7.5 | 10 kHz | 11.0 | 9.7% | 0.49 |
| 7.5 | 100 kHz | 10.4 | 3.9% | 0.52 |
| 7.5 | 1 MHz | 9.9 | −1.2% | 1.11 |

The results in Table 8 suggest that 10 kHz is a favorable frequency for flux enhancement as it consistently yielded enhancements of >7% in these trials. Flux enhancement was lower than that achieved for FO but that is currently attributed to a lower level of CP induced due to lower salinity test water.

Finally, the effect of applied external pressure was also investigated. The pressure scaling tests were performed at 100 and 200 psi.

TABLE 9
Results from pressure scaling as seen in RO benchtop module. The data
suggests that power consumption of the system is independent of applied
pressure, and that enhancement of the system is reduced as pressure
increases for the same concentration.

| Pressure | | | Flux | % | |
|---|---|---|---|---|---|
| (psi) | Bias (V) | Frequency | (L/m²h) | Enhancement | Power (W) |
| 100 | 0 | 0 | 4.8 | | |
| 100 | 1 | 10 kHz | 4.7 | −0.7% | 0.01 |
| 100 | 5 | 10 kHz | 6.4 | 33.7% | 0.25 |
| 100 | 10 | 10 kHz | 5.8 | 22.7% | 0.97 |
| 200 | 0 | 0 | 10.8 | | |
| 200 | 1 | 10 kHz | 8.7 | −18.9% | 0.01 |
| 200 | 5 | 10 kHz | 11.5 | 6.8% | 0.25 |
| 200 | 10 | 10 kHz | 11.1 | 2.7% | 0.97 |

As seen in the results presented in Table 9, flux enhancement was achieved at both 100 psi and 200 psi cases.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

What is claimed is:

1. A membrane separation apparatus, comprising
(a) a feed chamber and a permeation chamber separated by a fluid permeable membrane, wherein the permeable membrane comprises a separation side in contact with the feed chamber and a permeation side in contact with the permeation chamber;
(b) a primary electrode positioned at a fluid boundary layer on the separation side of the permeable membrane; and
(c) an AC voltage source configured to supply a voltage of between 0.5 and 10 V to the primary electrode.

2. The apparatus of claim 1, wherein the primary electrode is positioned at a location within 100 μm from the separation side of the permeable membrane.

3. The apparatus of claim 2, wherein the primary electrode comprises a conductive mesh.

4. The apparatus of claim 1, wherein the permeable membrane is plated with a conductive material on the separation side that acts as the primary electrode.

5. The apparatus of claim 2, further comprising a counter electrode positioned on the permeation side of the permeable membrane.

6. The apparatus of claim 5, wherein the counter electrode is positioned within the permeation chamber.

7. The apparatus of claim 5, wherein the counter electrode is positioned at a location within 100 μm μfrom the permeation side of the permeable membrane

8. The apparatus of claim 7, wherein the counter electrode comprises a conductive mesh.

9. The apparatus of claim 7, wherein the permeable membrane is plated with a conductive material on the permeation side that acts as the counter electrode.

10. The apparatus of claim 1, wherein the AC voltage source is configured to apply the voltage at an oscillation frequency between 1 kHz and 10 MHz.

11. The apparatus of claim 1, wherein the AC voltage source is a wave form generator.

12. The apparatus of claim 1, further comprising a fluid comprising retention components and permeation components in the feed channel, wherein the fluid comprises one or more charged species that can cause concentration polarization at the membrane surface.

13. The apparatus of claim 12, wherein the fluid is selected from the group consisting of a solution, a liquid-solid suspensoid, a liquid-liquid suspensoid, a sol, a gas mixture, a gas-solid suspensoid, a gas-liquid suspensoid, or an aerosol.

14. The apparatus of claim 12, further comprising a driving force on the fluid to allow at least part of the permeation components to pass through the permeable membrane and reach the permeation side of the separation membrane.

15. The apparatus of claim 14, wherein the driving force is selected from the group consisting of a pressure difference, a concentration difference, or a temperature difference.

16. The apparatus of claim 1, wherein the permeable membrane is a nanofiltration membrane, ultrafiltration membrane, microfiltration membrane, or reverse osmosis membrane.

17. The apparatus of claim 1, wherein the permeable membrane is constructed of a polymer selected from the group consisting of cellulose acetate, polysulfone, polyether sulfone, polyacrilonitrile, polyvinylidiene fluoride, polypropylene, polyethylene, polyvinyl chloride, polyvinyl alcohol, polyamide, and polyester.

18. A method for inhibiting concentration polarization of a permeable membrane, comprising positioning at least one electrode at the fluid boundary layer of the permeable membrane, and supplying an AC voltage of between 0.5 and 10 V to the electrode.

19. The method of claim 18, wherein the method enhances permeate flux of the membrane by at least 40%.

20. The method of claim 18, wherein the electrode is positioned at a location within 100 μm from the permeable membrane.

21. The method of claim 18, wherein the electrode comprises a conductive mesh.

22. The method of claim 18, wherein the permeable membrane is plated with a conductive material on the separation side that acts as the electrode.

23. The method of claim 18, wherein the AC voltage has an oscillation frequency between 1 kHz and 10 MHz.

24. The method of claim 18, wherein the permeable membrane is a nanofiltration membrane, ultrafiltration membrane, microfiltration membrane, or reverse osmosis membrane.

25. The method of claim 18, wherein the permeable membrane is constructed of a polymer selected from the group consisting of cellulose acetate, polysulfone, polyether sulfone, polyacrilonitrile, polyvinylidiene fluoride, polypropylene, polyethylene, polyvinyl chloride, polyvinyl alcohol, polyamide, and polyester.

26. A method for separating permeate from retentate in a fluid, comprising
(a) loading the fluid into the feed chamber of the membrane separation apparatus of claim 1; and
(b) applying a driving force on the fluid to allow at least part of the permeate to pass through the permeable membrane and reach the permeation side of the separation membrane.
